(19) United States
(12) Patent Application Publication
(10) Pub. No.: US 2004/0179933 A1
(43) Pub. Date: Sep. 16, 2004

(54) Pedestal/heater assembly lift mechanism with direct drive lead screw

(75) Inventors: Kuo-Hsi Huang, Fengyuan City (TW); Chang-Yi Hsieh, Pingtung (TW); Yang-Hai Fan, Hsinchu (TW); Shih-Chang Hsu, Hsinchu (TW); Hao-Quan Yu, Taipei (TW); Zheng-Zong Twu, Taipei (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/385,762

(22) Filed: Mar. 11, 2003

(51) Int. Cl. B65G 49/07

(52) U.S. Cl. 414/935; 74/89.23

(57) ABSTRACT

A new and improved lift mechanism which is suitably adapted for raising and lowering a pedestal/heater assembly inside a processing chamber for semiconductor wafer substrates. The pedestal/heater assembly lift mechanism includes a drive motor which is directly coupled through a shaft coupling to a threaded lead screw for rotating the lead screw in the clockwise or counterclockwise direction. The lead screw threadibly engages the pedestal/heater assembly for selectively raising and lowering the pedestal/heater assembly inside the processing chamber.

### FIELD OF THE INVENTION

The present invention relates to a lift mechanism for a pedestal/heater assembly in a process chamber for semiconductor substrates. More particularly, the present invention relates to a pedestal/heater assembly lift mechanism which includes a direct lead drive screw for transmitting driving rotation directly from a drive motor to a pedestal/heater assembly.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

In the semiconductor production industry, various processing steps are used to fabricate integrated circuits on a semiconductor wafer. These steps include the deposition of layers of different materials including metallization layers, passivation layers and insulation layers on the wafer substrate, as well as photoresist stripping and sidewall passivation polymer layer removal. In modern memory devices, for example, multiple layers of metal conductors are required for providing a multi-layer metal interconnection structure in defining a circuit on the wafer. A current drive in the semiconductor device industry is to produce semiconductors having an increasingly large density of integrated circuits which are ever-decreasing in size. These goals are achieved by scaling down the size of the circuit features in both the lateral and vertical dimensions. Vertical downscaling requires that the thickness of conductive and insulative films on the wafer be reduced by a degree which corresponds to shrinkage of the circuit features in the lateral dimension. Ultrathin device features will become increasingly essential for the fabrication of semiconductor integrated circuits in the burgeoning small/fast device technology.

Chemical vapor deposition (CVD) processes are widely used to form layers of materials on a semiconductor wafer. CVD processes include thermal deposition processes, in which a gas is reacted with the heated surface of a semiconductor wafer substrate, as well as plasma-enhanced CVD processes, in which a gas is subjected to electromagnetic energy in order to transform the gas into a more reactive plasma. Forming a plasma can lower the temperature required to deposit a layer on the wafer substrate, to increase the rate of layer deposition, or both. Other CVD processes include APCVD (atmospheric pressure chemical vapor deposition), and LPCVD (low pressure chemical vapor deposition). While APCVD systems have high equipment throughput, good uniformity and the capability to process large-diameter wafers, APCVD systems consume large quantities of process gas and often exhibit poor step coverage. Currently, LPCVD is used more often than APCVD because of its lower cost, higher production throughput and superior film properties. LPCVD is commonly used to deposit nitride, TEOS oxide and polysilicon films on wafer surfaces for front-end-of-line (FEOL) processes.

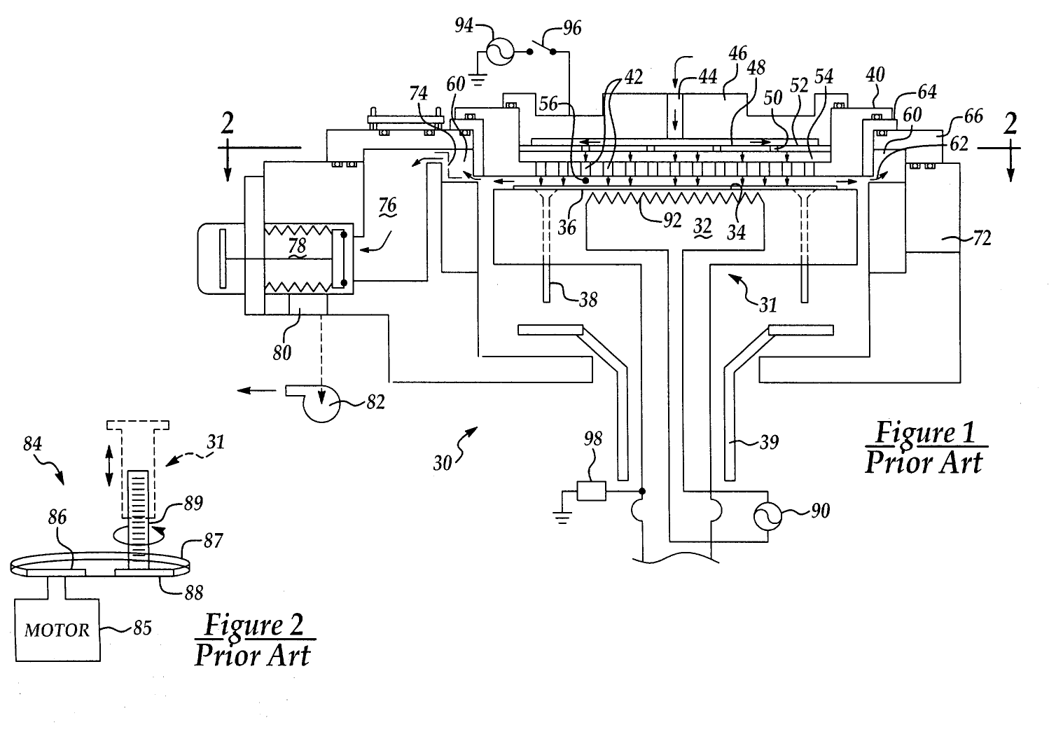

A conventional CVD chamber 30, such as a Centura DxZ CVD chamber available from Applied Materials, Inc., of Santa Clara, Calif., is shown in cross-section in FIG. 1. The CVD chamber 30 includes a pedestal/heater assembly 31 having a pedestal 32 which contains a heater 92 and has a wafer supporting surface 34 on which a wafer 36 to be subjected to the CVD process is supported. Lift pins 38 are slidably mounted in the pedestal 32, and the lower ends of the lift pins 38 are engaged by a vertically movable lift ring 39 which extends the lift pins 38 from the surface 34 of the pedestal 32. The pedestal/heater assembly 31 is vertically movable by actuation of a mechanism which will be hereinafter described. After a robot blade (not shown) transfers the wafer 36 into the chamber 30, the lift pins 38 initially lift the wafer 36 off the robot blade and the pedestal 32 then raises the wafer 36 from the lift pins 38 and onto the supporting surface 34.

The pedestal 32 further raises the wafer 36 into close proximity to a gas distribution plate (GDP) or “showerhead” 40 which includes passageways 42 that dispense a process gas into a processing space 56 towards the wafer 36. The process gas is initially injected into the chamber 30 through a central gas inlet 44 in a gas-feed cover plate 46, into a disk-shaped manifold 48, through passageways 50 in a baffle plate 52, through a second disk-shaped manifold 54 in the rear portion of the showerhead 40, and finally, through the passageways 42 in the showerhead 40. The process gas reacts with the surface of the wafer 36 to deposit the material in a layer on the wafer 36. Unreacted process gas and reaction byproducts flow radially outwardly to an annular pumping channel 60 that surrounds the upper periphery of the pedestal 32. The pumping channel 60 is connected through a constricted exhaust aperture 74 to a pumping plenum 76, and a valve gate 78 gates the exhaust through an exhaust vent 80 to a vacuum pump 82. Accordingly, the process gas and its reaction byproducts flow from the center of the showerhead 40 across the surface of the wafer 36 and toward the periphery of the pedestal 32 along radial paths, and then to the pumping channel 60 through a choke aperture 62. The gas then flows circumferentially in the pumping channel 60, to the exhaust aperture 74 and then through the exhaust plenum 76 and the exhaust vent 80, respectively, to the vacuum pump 82. Because of restrictions 62, 74, in the gas flow path, the radial flow of the gas across the wafer 36 is nearly uniform in the horizontal direction.

The CVD chamber 30 is capable of operation in either of two modes, a thermal mode and plasma-enhanced mode. In the thermal mode, an electrical power source 90 supplies power to the heater 92 in the top portion of the pedestal 32 to heat the pedestal 32, and thus, the wafer 36 to a temperature sufficient to thermally activate the CVD reaction. In the plasma-enhanced mode, an RF electrical source 94 is passed by a switch 96 to the metallic showerhead 40, which thus acts as an electrode. The showerhead 40 is electrically insulated from the lid rim 66 and the main chamber body 72 by an annular isolator ring 64, which is typically formed of an electrically non-conductive ceramic. The pedestal 32 is connected to a biasing element 98 associated with the RF source 94 such that RF power is split between the showerhead 40 and the pedestal 32. Sufficient voltage and power is applied by the RF source 94 to cause the process gas in the processing space 56 between the showerhead 40 and the pedestal 32 to discharge and form a plasma.

A schematic view of a conventional lift mechanism 84 for the pedestal/heater assembly 31 is shown in FIG. 2 and includes a drive motor 85 that directly engages a drive pulley 86. A driven pulley 88 is provided on the bottom end portion of a threaded lead screw 89 that threadibly engages the pedestal/heater assembly 31. A drive belt 87 trained around the drive pulley 86 and the driven pulley 88 connects the drive motor 85 to the lead screw 89 in parallel. Thus, the drive belt 87 transmits rotation from the drive motor 85 to the lead screw 89 to facilitate raising and lowering along the Y-axis of the pedestal/heater assembly 31 in the CVD chamber 30.

The conventional belt-driven lift mechanism 31 has several drawbacks, one being inordinate failure of the drive belt 87 to precisely transfer rotation from the drive pulley 86 to the driven pulley 88 and achieve the intended vertical or Y-axis translation of the pedestal/heater assembly 31 within the chamber 30. This problem, usually caused by a gradual loss of elasticity in the drive belt 87, results in non-uniform coating of the CVD material on the wafer 34, as well as potential damage to the wafer transfer robot and scratching of and/or damage to the wafer 34. This additionally causes activation of the re-homing alarm for the lift mechanism, requiring re-working and sometimes scrapping of the wafer 34 as well as downtime and maintenance or repair of the CVD process tool. Another drawback of the conventional belt-driven lift mechanism 31 is that the horizontal force exerted against the driven pulley 88 by the drive belt 87 causes excessive and premature wearing of a lead screw bearing (not shown) through which the lead screw 89 extends. Accordingly, a new and improved lift mechanism is needed for accurately, reliably and efficiently transmitting rotational force from a drive motor to a lead screw for a pedestal/heater assembly in a process chamber.

An object of the present invention is to provide a new and improved lift mechanism for a pedestal/heater assembly in a processing chamber for semiconductor wafers.

Another object of the present invention is to provide a new and improved pedestal/heater assembly lift mechanism for a process chamber, which pedestal/heater assembly is characterized by reliable and essentially trouble-free operation.

Another object of the present invention is to provide a new and improved pedestal/heater assembly lift mechanism which is compatible with pedestal/heater assemblies of a variety of process chambers for substrates.

Still another object of the present invention is to provide a new and improved pedestal/heater assembly lift mechanism for transmitting drive rotation directly from a drive motor to a lead screw for Y-axis movement of a pedestal/heater assembly.

A still further object of the present invention is to provide a new and improved pedestal/heater assembly lift mechanism which is economical and efficient in operation.

Yet another object of the present invention is to provide a new and improved pedestal/heater assembly lift mechanism which significantly improves product yield in the fabrication if integrated circuits on semiconductor wafer substrates.

A still further object of the present invention is to provide a new and improved pedestal/heater assembly lift mechanism which utilizes a lead screw directly coupled to a drive motor to facilitate the selective raising and lowering of a pedestal/heater assembly in a process chamber.

Yet another object of the present invention is to provide a new and improved lift mechanism for a pedestal/heater assembly in a process chamber, which lift mechanism may be retrofitted to existing pedestal/heater assemblies.

### SUMMARY OF THE INVENTION

In accordance with these and other objects and advantages, the present invention is generally directed to a new and improved lift mechanism which is suitably adapted for raising and lowering a pedestal/heater assembly along a Y-axis inside a processing chamber for semiconductor wafer substrates. The pedestal/heater assembly lift mechanism includes a drive motor which is directly coupled through a shaft coupling to a threaded lead screw for rotating the lead screw in the clockwise or counterclockwise direction. The lead screw threadibly engages the pedestal/heater assembly for selectively raising and lowering the pedestal/heater assembly inside the processing chamber. Accordingly, the shaft coupling directly transmits rotation from the drive motor to the lead screw to facilitate raising or lowering of the pedestal/heat assembly without the possibility of slippage between the drive motor and the lead screw.

The lift mechanism may further include a coupling support block having a coupling cradle for supporting the shaft coupling. The shaft coupling may include a motor shaft collar provided on a motor shaft engaged by the motor, a lead screw collar provided on the lead screw, and bottom coupling splines provided on the motor shaft collar and meshing with companion top coupling splines on the lead screw collar. A shaft bearing block, within which is mounted a shaft bearing through which the lead screw extends, may be provided on the coupling support block. An assembly mount block or flange may be provided on the shaft bearing block or other element of the lift assembly to facilitate retrofitting the lift assembly to a structural mounting element on the CVD or other process tool.

### BRIEF DESCRIPTION OF THE PREFERRED EMBODIMENTS

The invention will now be described, by way of example, with reference to the accompanying drawings, in which:

FIG. 1 is a cross-sectional view of a typical conventional CVD (chemical vapor deposition) chamber suitable for implementation of the present invention;

FIG. 2 is a schematic view of a conventional lift mechanism for a pedestal/heater assembly of the CVD chamber shown in FIG. 1;

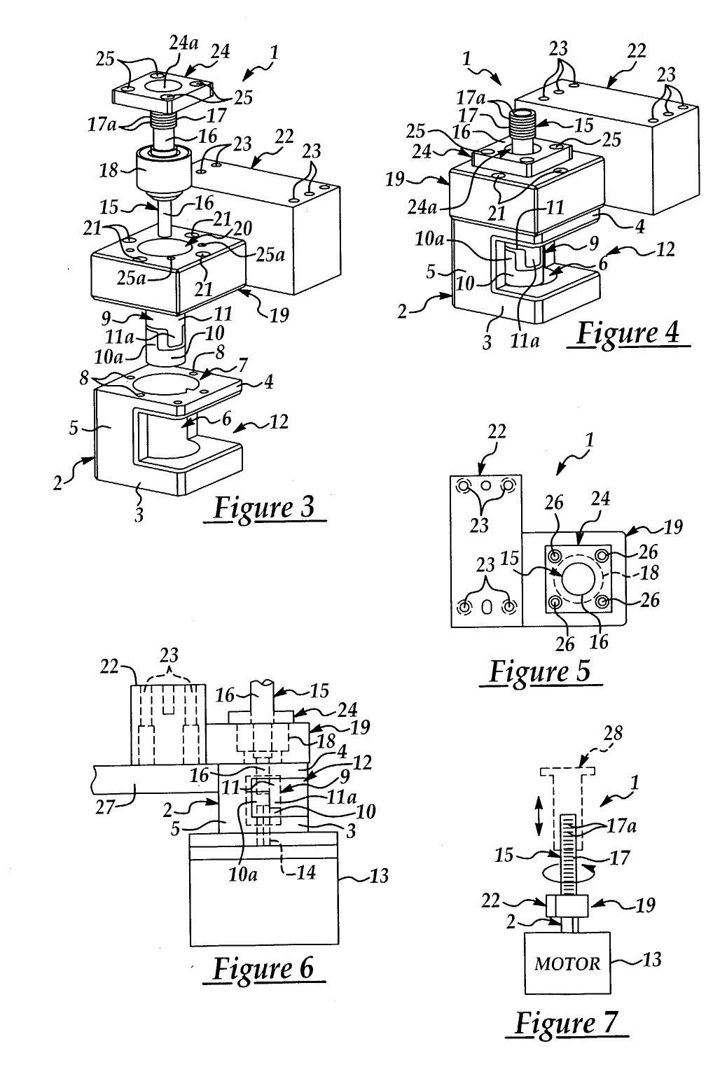

FIG. 3 is an exploded, perspective view of a pedestal/heater assembly lift mechanism of the present invention;

FIG. 4 is a perspective view of the assembled lift mechanism of the present invention;

FIG. 5 is a top view of the lift mechanism;

FIG. 6 is a side view of the assembled lift mechanism, mounted on a process tool in implementation of the present invention; and

FIG. 7 is a schematic view of the lift mechanism in implementation of the invention.

### DESCRIPTION OF THE PREFERRED EMBODIMENTS

The present invention has particularly beneficial utility in the selective raising and lowering of a pedestal/heater assembly inside a CVD chamber used in the deposition of material layers on a semiconductor wafer substrate, and is particularly suitable for raising and lowering a pedestal/heater assembly inside a Centura DxZ chamber available from Applied Materials, Inc., of Santa Clara, Calif. However, the invention is not so limited in application, and while references may be made to such CVD chamber, the invention is more generally applicable to raising and lowering pedestal assemblies or substrate supports in chambers used for carrying out other semiconductor fabrication processes or other industrial applications.

Referring to FIGS. 3-7, an illustrative embodiment of the lift assembly of the present invention is generally indicated by reference numeral 1 and includes a drive motor 13 that drivingly engages a motor shaft 14, as shown in FIG. 6. A typically aluminum coupling support block 2, which may have a base portion 3 which engages the upper surface of the drive motor 13, includes a vertical intermediate portion 5 which extends from the base portion 3 and a top portion 4 which extends horizontally from the intermediate portion 5, in generally parallel relationship to the base portion 3. A coupling cradle 6 is provided in the base portion 3 and intermediate portion 5, and communicates with a top opening 7 that extends through the top portion 4. The coupling cradle 6 further communicates with a bottom opening (not shown) which extends downwardly through the base portion 3 and receives the motor shaft 14. A coupling access gap 12, the purpose of which will be hereinafter described, is defined between the base portion 3 and the top portion 4.

As shown in FIG. 6, a shaft coupling 9, contained in the coupling cradle 6 of the coupling support block 2, couples the motor shaft 14 with the bottom unthreaded portion 16 of a lead screw 15 having a threaded portion 17 with lead screw threads 17a above the unthreaded portion 16. The motor shaft 14 engages a bottom motor shaft collar 10 of the shaft coupling 9, whereas the unthreaded lower end portion 16 of the lead screw 15 engages a top lead screw collar 11 of the shaft coupling 9. The motor shaft collar 10 includes multiple drive splines 10a which mesh with multiple companion driven splines 11a on the lead screw collar 11 of the shaft coupling 9. It is understood that the shaft coupling 9 may have alternative configurations known by those skilled in the art for coupling the drive collar 14 to the lead screw 15. As shown in FIG. 7 and hereinafter further described, the threaded portion 17 of the lead screw 15 threadibly engages a pedestal/heater assembly 28 of a CVD or other processing chamber (not shown), in conventional fashion.

A typically rectangular shaft bearing block 19, which may be aluminum, is typically mounted on the upper surface of the top portion 4 of the coupling support block 2, typically using multiple block mount bolts (not shown) which extend downwardly through respective mount bolt openings 21 in the shaft bearing block 19 and are threaded into respective bolt openings 8 in the top portion 4. A central bearing opening 20 extends vertically through the shaft bearing block 19. A cylindrical shaft bearing 18, through which extends the unthreaded portion 16 of the lead screw 15, is seated in the bearing opening 20. A typically rectangular bearing retainer plate 24 is mounted on the upper surface of the shaft bearing block 19, typically by extending multiple plate mount bolts (not shown) through respective mount bolt openings 25 provided in the bearing retainer plate 24 and threading the plate mount bolts into respective mount bolt openings 25a in the shaft bearing block 19, to retain the shaft bearing 18 in the bearing opening 20. The lead screw 15 extends upwardly through a central plate opening 24a provided in the bearing retainer plate 24, as shown in FIG. 4.

An assembly mount block 22 which may be aluminum may be welded or otherwise attached to the shaft bearing block 19 to facilitate mounting the lift assembly 1 to the CVD or other process tool (not shown). The assembly mount block 22 may include multiple mount bolt openings 23 in opposite ends thereof which receive respective mount bolts (not shown) that are threaded into a structural mounting element 27 (FIG. 6) of the process tool.

Referring next to FIG. 7, in operation the lift assembly 1 is used to raise and lower a pedestal/heater assembly 28 along the Y-axis inside a processing chamber such as a CVD chamber (not shown), for such purposes as lifting a wafer (not shown) from wafer lift pins (not shown) onto the pedestal/heater assembly 28 and positioning the wafer into proximity with a plasma or gas in the processing chamber, as heretofore described with respect to FIGS. 1 and 2 in the background section. Accordingly, raising of the pedestal/heater assembly 28 is facilitated by clockwise or counterclockwise rotation of the lead screw 15, depending on whether the lead screw 15 has right-handed or left-handed threads 17a, by operation of the drive motor 13 as the lead screw threads 17a threadibly engage the interior assembly threads (not shown) inside the pedestal/heater assembly 28. In similar fashion, lowering of the pedestal/heater assembly 28 is facilitated by rotation of the lead screw 15 by operation of the drive motor 13 in the opposite direction. It will be appreciated by those skilled in the art that because the shaft coupling 9 directly couples the motor shaft 14 to the lead screw 15, rotation is reliably transmitted to the lead screw 15 without the possibility of slippage occurring between the motor shaft 14 and the lead screw 15 at the coupling 9. Therefore, precise vertical or Y-axis translation of the pedestal/heater assembly 28 within the process chamber can be accomplished throughout the CVD or other process, substantially enhancing process uniformity and quality. The shaft bearing 18 stabilizes the lead screw 15 in the vertical driving orientation during raising and lowering of the pedestal/heater assembly 28. The shaft coupling 9 may be accessed for replacement or maintenance, as needed, through the coupling access gap 12 of the coupling support block 2.

While the preferred embodiments of the invention have been described above, it will be recognized and understood that various modifications can be made in the invention and the appended claims are intended to cover all such modifications which may fall within the spirit and scope of the invention.

What is claimed is:

1. A lift mechanism for a substrate support of a process chamber, comprising:
a drive motor having a motor shaft;
a shaft coupling engaging said motor shaft; and
a lead screw engaged by said shaft coupling for threadibly engaging the substrate support.

2. The lift mechanism of claim 1 further comprising a coupling support block carried by said drive motor and wherein said shaft coupling is provided in said coupling support block.

3. The lift mechanism of claim 1 wherein said shaft coupling comprises a motor shaft collar engaged by said motor shaft, at least one bottom spline extending from said motor shaft collar, a lead screw collar engaged by said lead screw, and at least one top spline extending from said lead screw collar for engaging said at least one bottom spline.

4. The lift mechanism of claim 3 further comprising a coupling support block carried by said drive motor and wherein said shaft coupling is provided in said coupling support block.

5. The lift mechanism of claim 1 further comprising a shaft bearing block carried by said drive motor and a shaft bearing provided in said shaft bearing block and wherein said lead screw extends through said shaft bearing.

6. The lift mechanism of claim 5 further comprising a coupling support block carried by said drive motor and wherein said shaft coupling is provided in said coupling support block and said shaft bearing block is provided on said coupling support block.

7. The lift mechanism of claim 5 wherein said shaft coupling comprises a motor shaft collar engaged by said motor shaft, at least one bottom spline extending from said motor shaft collar, a lead screw collar engaged by said lead screw, and at least one top spline extending from said lead screw collar for engaging said at least one bottom spline.

8. The lift mechanism of claim 7 further comprising a coupling support block carried by said drive motor and wherein said shaft coupling is provided in said coupling support block and said shaft bearing block is provided on said coupling support block.

9. A lift mechanism for a substrate support of a process chamber, comprising:
a lead screw for threadibly engaging the substrate support;
a drive motor having a motor shaft disposed in substantially aligned relationship to said lead screw; and
a shaft coupling connecting said lead screw to said motor shaft.

10. The lift mechanism of claim 9 further comprising a coupling support block carried by said drive motor and having a coupling cradle containing said shaft coupling and a coupling access gap for providing access to said shaft coupling.

11. The lift mechanism of claim 9 wherein said shaft coupling comprises a motor shaft collar engaged by said motor shaft, at least one bottom spline extending from said motor shaft collar, a lead screw collar engaged by said lead screw, and at least one top spline extending from said lead screw collar for engaging said at least one bottom spline.

12. The lift mechanism of claim 11 further comprising a coupling support block carried by said drive motor and having a coupling cradle containing said shaft coupling and a coupling access gap for providing access to said shaft coupling.

13. The lift mechanism of claim 9 further comprising a shaft bearing block carried by said drive motor and a shaft bearing provided in said shaft bearing block and wherein said lead screw extends through said shaft bearing.

14. The lift mechanism of claim 13 further comprising a coupling support block carried by said drive motor and having a coupling cradle containing said shaft coupling and a coupling access gap for providing access to said shaft coupling and wherein said shaft bearing block is provided on said coupling support block.

15. The lift mechanism of claim 13 wherein said shaft coupling comprises a motor shaft collar engaged by said motor shaft, at least one bottom spline extending from said motor shaft collar, a lead screw collar engaged by said lead screw, and at least one top spline extending from said lead screw collar for engaging said at least one bottom spline.

16. The lift mechanism of claim 15 further comprising a coupling support block carried by said drive motor and having a coupling cradle containing said shaft coupling and a coupling access gap for providing access to said shaft coupling and wherein said shaft bearing block is provided on said coupling support block.

17. A lift mechanism for a substrate support of a process chamber, comprising:
a lead screw for threadibly engaging the substrate support;
a drive motor having a motor shaft disposed in substantially aligned relationship to said lead screw;
a shaft coupling connecting said lead screw to said motor shaft; and
an assembly mount block carried by said drive motor for mounting said lift mechanism on the process chamber.

18. The lift mechanism of claim 17 further comprising a coupling support block carried by said drive motor and wherein said shaft coupling is provided in said coupling support block.

19. The lift mechanism of claim 17 wherein said shaft coupling comprises a motor shaft collar engaged by said motor shaft, at least one bottom spline extending from said motor shaft collar, a lead screw collar engaged by said lead screw, and at least one top spline extending from said lead screw collar for engaging said at least one bottom spline.

20. The lift mechanism of claim 18 further comprising a shaft bearing block carried by said coupling support block and a shaft bearing provided in said shaft bearing block and wherein said lead screw extends through said shaft bearing and said assembly mount block is provided on said shaft bearing block.
